(19) United States
(12) Patent Application Publication
(10) Pub. No.: US 2012/0045202 A1
(43) Pub. Date: Feb. 23, 2012

(54) High Speed Bi-Directional Transceiver, Circuits and Devices Therefor, and Method(s) of Using the Same

(76) Inventors: Xu Jiang, Chengdu (CN); Yi Yang, Chengdu (CN); Yong Lu, Chengdu (CN); Yuan Song, Chengdu (CN)

(21) Appl. No.: 13/105,550

(22) Filed: May 11, 2011

(30) Foreign Application Priority Data
Aug. 17, 2010 (CN) 201010254908.7
Sep. 25, 2010 (CN) 201010290187.5

(51) Int. Cl. H04B 10/08; H04B 10/02

(52) U.S. Cl. 398/38; 398/136; 398/138

(57) ABSTRACT

The present disclosure relates to a high-speed and/or power-saving bi-directional transceiver. The transceiver generally includes a (burst) laser driver; an output power monitoring and indicating circuit; control logic (e.g., a microcontroller unit); bi-directional optics; a photodiode bias control circuit; a limiting amplifier; and a receiver optical power monitoring circuit. Optionally, the present transceiver includes a small form factor pluggable (SFP+) connector housing. In addition, the power-saving bi-directional transceiver generally includes a transmitter (TX) energy-saving circuit, a TX burst holding circuit, a receiver (RX) energy-saving circuit, a RX continuous holding circuit and the control logic.

### CROSS REFERENCE TO RELATED APPLICATION

This application claims the benefit of Chinese Patent Application Nos. 201010254908.7 and 201010290187.5, filed on Aug. 17, 2010 and Sep. 25, 2010, respectively, and each of which is incorporated herein by reference as if fully set forth herein.

### FIELD OF THE INVENTION

The present invention generally relates to the field of optical data communications and network technology. More specifically, embodiments of the present invention pertain to a high speed, bi-directional optical network transceiver, particularly circuits, devices and an optical network unit (ONU) therefor, and method(s) of making and/or using the same. In one embodiment, the transceiver is a small form factor pluggable (e.g., SFP+ compatible) 10 G Ethernet passive optical network (EPON) transceiver. Embodiments of the present invention also pertain to a 10 G bi-direction transceiver with an energy-saving function, circuits and devices therefor, and method(s) of making and/or using the same.

### DISCUSSION OF THE BACKGROUND

With the popularization of FTTX technology, the wide availability of high-speed bandwidth has beneficially transformed society. For example, SOHO technology provides accessible high-definition interactive video programs, telemedicine and remote education. As demand for bandwidth increases, existing 1 G EPON technology is not ideally suited to meet today's needs. Furthermore, the circuits and optics of conventional 10 G technology consume excessive power, which can affect normal communication. Thus, the higher bandwidth of the 10 G EPON ONU transceivers and the ability to reduce energy consumption are attractive solutions to problems related to insufficient bandwidth and excessive consumption of power in optical networks.

In transceivers, detecting input optical power and output optical power may allow users to obtain real-time monitoring information of the transceiver, and ensure adequate performance and proper operation. In traditional continuous-mode transmitters, optical power data is derived from a monitor photodiode (MPD) current, wherein the MPD current is approximately proportional to the output optical power. However, during a burst mode of operation, the laser is on and provides light for a relatively brief duration of time, which can vary from one moment in time to the next. Thus, it can be difficult to quickly and accurately indicate the output optical power and value. Additionally, since the optical signal (e.g., the laser) operates at a rate of 10 Gb/s, it can still be problematic to ensure the receiver (RX) receptivity and the ability to monitor the RX optical power in real time. Thus, the burst mode of operation conforms to this time sequence (e.g., 10 Gs/s) and the transmitter (TX) communication index of the 10 G EPON system simultaneously.

Furthermore, with existing 10 G solutions, it is difficult to reduce instantaneous power consumption in the 10 G circuit and optics. For example, as shown in FIG. 1, in a Passive Optical Network (PON) 100, an Optical Line Terminal (OLT) transceiver 110 may be connected via optical splitter 130 with thirty-two (32) or more Optical Network Unit (ONU) transceivers 120a-120z. The uplink function provided by an ONU transmitter (e.g., 120a) cooperates with the OLT 110 via time division multiplexing. Downstream operations adopt the OLT broadcasting protocol to transmit a communication signal to an ONU receiver (e.g., 122a), and the ONU (e.g., 120a) receives the signal according to the system requirements. Due to the complexity of the burst communication mode of the PON system 100, such a solution has the following difficulties: a) the transceiver (TX) 124a and receiver 126a need to be controlled to achieve a high energy saving efficiency; b) a quick response of energy-saving and normal modes is desired to ensure normal communication of the system 100; c) the work status must be saved before the TX 124a and RX 126a switch to an energy-saving mode, and the saved information must be recovered after resuming a working state; and d) the ONU transceiver 122a cannot communicate with the OLT 110 after the RX 126a (or circuit[s] therein) is turned off. Consequently, the PON system 100 may not be able to effectively control the RX energy-saving circuit.

The present disclosure overcomes disadvantages of the existing technology (e.g., insufficient bandwidth and excessive consumption of power). Advantages of the present bi-directional transceiver include a low design cost, a simple circuit design that makes use of system silence to save energy and reduce consumption without affecting normal communication of the optical network (e.g., a 10 G EPON system) and that provides a real-time indication of the burst-mode optical output power.

### SUMMARY OF THE INVENTION

Embodiments of the present invention relate to a high-speed and/or power-saving bi-directional transceiver comprising a burst laser driver; a burst output power monitoring and indicating circuit; control logic (e.g., a microcontroller unit); bi-directional optics; an avalanche photodiode (APD) bias control circuit; a limiting amplifier; and a receiver optical power monitoring circuit. Optionally, the present transceiver includes (and is packaged in) a small form factor pluggable (SFP+) connector housing. The present ONU transceiver provides an effective solution to reduce energy and/or power consumption during a silent operational mode, without significant adverse effects on normal communications in the PON system.

Various embodiments of the present invention also relate to a high-speed and/or energy-saving bi-directional transceiver comprising a transmitter (TX) burst energy-saving circuit; a TX burst holding circuit; a receiver (RX) continuous energy-saving circuit; a RX continuous holding circuit; and control logic (e.g., a microcontroller, microprocessor, signal processor, ASIC, etc.) configured to control one or more of the TX burst energy-saving circuit, TX burst holding circuit, RX continuous energy-saving circuit and RX continuous holding circuit. In accordance with a dynamic time slot, the TX energy-saving circuit turns off all functional components of the transmitter during an idle time (e.g., when the transmitter enters an idle or stand-by mode), and together with the burst holding circuit, quickly resumes normal functions during working time (e.g., when the transmitter is to enter an operational mode). The continuous RX energy-saving circuit quickly turns off the receiver circuitry during a silent time (e.g., an idle or stand-by mode) and, together with the RX burst holding circuit, enables the receiver to resume the work state (e.g., an operational mode) according to the system requirements. The control logic saves an RX status and provides access to and/or by energy-saving software.

In various embodiments of the present invention, a laser capable of operating in a burst mode and the burst laser driver are able to output an optical signal satisfying both a time-multiplexing sequence and the optical communication requirements for 10 G EPON communication systems by control of external control logic. The burst output power monitoring and indicating circuit allows real-time indications and monitoring of the optical signals with varying burst duration. The internal control logic (e.g., an MCU), which may store information for a common commercial operating temperature range (e.g., of about 0° C. to about 70° C.) of the laser, compensates for or controls the temperature-dependent variation(s) in laser output by providing (i) a bias current and a modulation current to the laser and (ii) a bias voltage of the APD via a sampling circuit, which ensures that the optical functions are not affected by temperature, thereby meeting signal transmission requirements in burst mode and receiver signal requirements in continuous mode.

Under the control of the burst control logic, the burst laser driver and the laser can convert a 10 gigabyte per second (Gb/s) electrical signal to a stable optical signal within nanoseconds. The burst output power monitoring and indicating circuit is configured to indicate the power and the level or wavelength of the transmitted optical signal.

The receiver generally comprises the APD and a transimpedance amplifier (TIA), which are used for high-speed conversion of the received optical signal to a low-voltage electrical signal. Subsequently, the signal is reformatted, and the received data (RXD) is amplified with a limiting amplifier that may have a clock recovery function to provide an electrical output and an optional recovered clock. The clock recovery function ensures that the output signal satisfies the requirements of a 10 G EPON RX signal with respect to amplitude and fluctuation(s). Furthermore, the limiting amplifier enables indication of a RX signal by providing a high-level signal when the input signal is within an acceptable range.

Compensation for the optical output power, the modulation current of the laser, and the bias voltage of the APD over an entire (e.g., predetermined) temperature range is performed via the control logic (e.g., MCU). First, the correlation between a compensation value for the optical output power, modulation current, and/or bias voltage based on the temperature is obtained through testing (e.g., empirical testing and/or calibration). Second, a lookup table is created (e.g., in memory associated with and/or accessible by the control logic) according to the correlation. Lastly, the control logic compensates, in real time, for the temperature-dependent variations in the optical power output, the modulation current of the laser, and the bias voltage of the APD throughout an entire predetermined temperature range according to the lookup table.

With respect to conventional technology, the present invention provides a burst laser driver and an RX limiting amplifier capable of operating in a 10 Gb/s network, integrated on a single chip to reduce the cost of the components and the layout space/area of the design. Secondly, the burst laser driver controls the burst signal output of the laser via the control logic and provides an automatic power control loop that allows for current sampling. Deterioration of the optical power due to laser aging is reduced, and burst laser performance can be regulated and adjusted without additional external circuitry (e.g., switching logic and analog sampling circuitry). To realize system performance reporting, the burst optical power indicating circuit and the control logic monitor the burst power, so as to realize system performance reporting. The present limiting amplifier with RX signal indication circuitry and optional clock recovery circuitry satisfies the requirements of 10 Gb/s optical networks with respect to the signal amplitude and fluctuation, ensuring accurate transmission of the optical signals and accurate monitoring of the RX optical signals.

In various embodiments of the present invention, Optical Line Termination (OLT) bandwidth is allocated by time division multiplexing (TDM; e.g., burst TDM) in an uplink PON system, in which the TX (or circuits thereof) can be turned off by the TX burst energy-saving circuit. When the TX function (e.g., the uplink transmission) is idle, the TX burst holding circuit (e.g., in response to a respective control signal provided by the PON system) turns off the transmitter or a number of circuits in the transmitter, saving energy in and the operational status of the transmitter. When uplink transmissions and/or communications are needed, the transmitting function of the ONU transceiver can be quickly resumed according to the saved operational status.

Optionally, the ONU transceiver may receive OLT downlink service (e.g., data, instructions, etc.). When downstream operations and data are not received by the system, the RX (and/or circuits thereof) can be turned off according to the respective control signal from the PON system, saving energy in and the operational status of the receiver. When downlink operations are needed, the receiving function of the ONU transceiver can be quickly resumed according to the saved operational status.

The control logic in the ONU transceiver is configured to provide control signals to the respective circuits in the transmitter or receiver according to the system control logic. The internal control logic saves operational status information of the TX and/or RX to ensure interoperation of all functional circuits. Furthermore, the control logic may provides to an interface control register energy-saving software to realize a real-time monitor for the ONU transceiver in both the energy-saving (e.g., power-down, stand-by or idle) and working (e.g., operational) modes.

Compared to conventional 10 G ONU technology, the present invention advantageously provides one or more energy-saving control circuits that reduce maximal consumption during transceiver silence, and are capable of switching parts of the transceiver to working or energy-saving modes (e.g., according to external system control logic), ensuring normal communications. The internal control logic (e.g., a microcontroller) can efficiently coordinate all transmitter and receiver functional circuits and allow operational status inquiries. Thus, the present invention overcomes the disadvantage of high power consumption in existing 10 G symmetrical ONU technology, and provides an energy saving circuit for bi-directional transceivers to effectively reduce energy consumption of ONUs in a PON system (e.g., a 10 Gb/s EPON system).

These and other advantages of the present invention will become readily apparent from the detailed description of various embodiments below.

### BRIEF DESCRIPTION OF THE DRAWINGS

FIG. 1 is a diagram of a system including an Optical Line Terminal (OLT) and multiple ONU transceivers.

FIG. 2 is a diagram showing an exemplary SFP+ 10 G EPON ONU transceiver according to the present invention.

FIG. 3 is a diagram showing an exemplary SFP+ 10 G EPON ONU transmitter according to the present invention.

FIG. 4 is a diagram showing an exemplary circuit configured to monitor and indicate the burst output power according to the present invention.

FIG. 5 is a diagram showing exemplary SFP+ 10 G EPON ONU energy saving control circuitry according to the present invention.

FIG. 6 is a diagram showing an exemplary SFP+ 10 G EPON ONU TX energy saving control circuit according to the present invention.

FIG. 7 is a diagram showing an exemplary SFP+ 10 G EPON ONU RX energy saving control circuit according to the present invention.

FIG. 8 is a diagram showing four (4) working states of exemplary SFP+ 10 G EPON ONU transceivers according to the present invention.

FIG. 9 is a diagram showing turn-on and turn-off times for exemplary SFP+ 10 G EPON ONU transceivers according to the present invention.

### DETAILED DESCRIPTION

Reference will now be made in detail to various embodiments of the invention, examples of which are illustrated in the accompanying drawing(s). In order to achieve the objectives, technical solutions and advantages of the present invention more clearly, further details of the invention are described below with regard to the Figure(s). While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention. The embodiments described here are only used to explain, rather than limit, the invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise. Each characteristic is generally only an embodiment of the invention disclosed herein.

For the sake of convenience and simplicity, the terms “connected to,” “coupled with,” “coupled to,” and “in communication with” (which terms also refer to direct and/or indirect relationships between the connected, coupled and/or communicating elements, unless the context of the term's use unambiguously indicates otherwise) are generally used interchangeably herein, but are generally given their art-recognized meanings

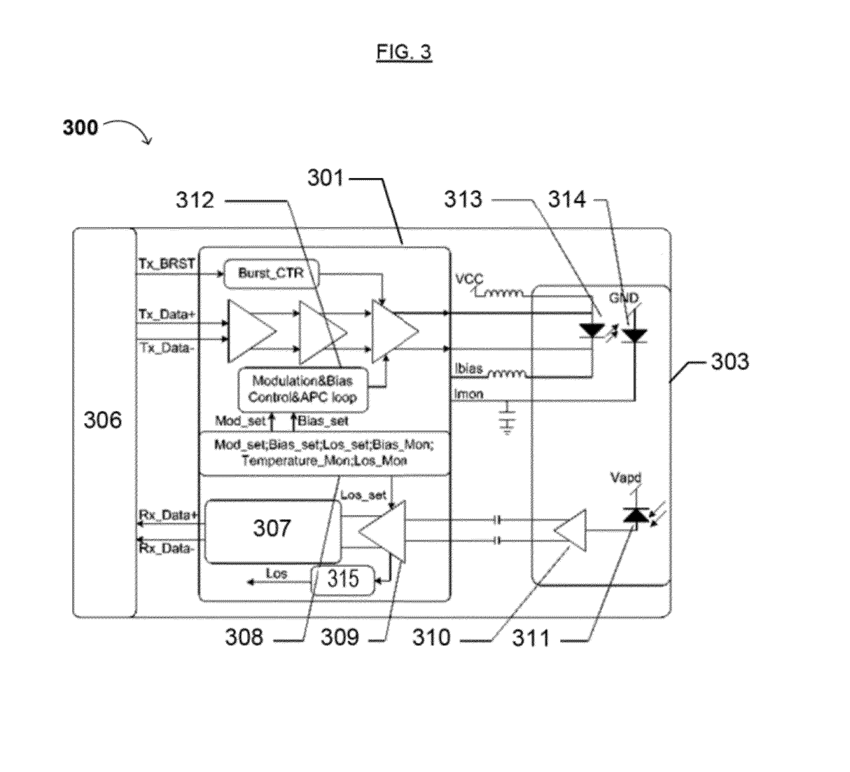

In various embodiments, and referring now to FIGS. 2-4, an exemplary transceiver 200 comprises a 10 Gb/s single-chip burst laser driver and limiting amplifier unit 201, a micro-controller unit (MCU) 202, a bi-directional optical sub-assembly (BOSA) 203, an avalanche photodiode (APD) bias control circuit 204, a burst power indicating and monitoring circuit 205, a connector 206, a RX clock recovery circuit 307, a transmission control circuit 308, a limiting amplifier (LA) 309, a transimpedance amplifier (TIA) 310, an APD 311, an automatic power control circuit (APC) 312, a laser 313, a monitor photodiode (MPD) 314, a RX power indicating circuit 315, an APD booster and RX power monitoring circuit 416, and a burst power indicating circuit 417.

Referring to FIG. 2, an exemplary embodiment of a SFP+ 10 G EPON ONU transceiver 200 comprises a 10 Gb/s (10 G) single-chip burst laser driver and limiting amplifier 201, the microcontroller unit (MCU) 202, the bi-directional optical sub-assembly (BOSA) 203, the avalanche photodiode (APD) bias control circuit 204, the burst power indicating and power monitoring circuit 205 and an SFP+ connector 206. The SFP+ connector 206 may be configured for connection to an electronic host device in an optoelectronic network.

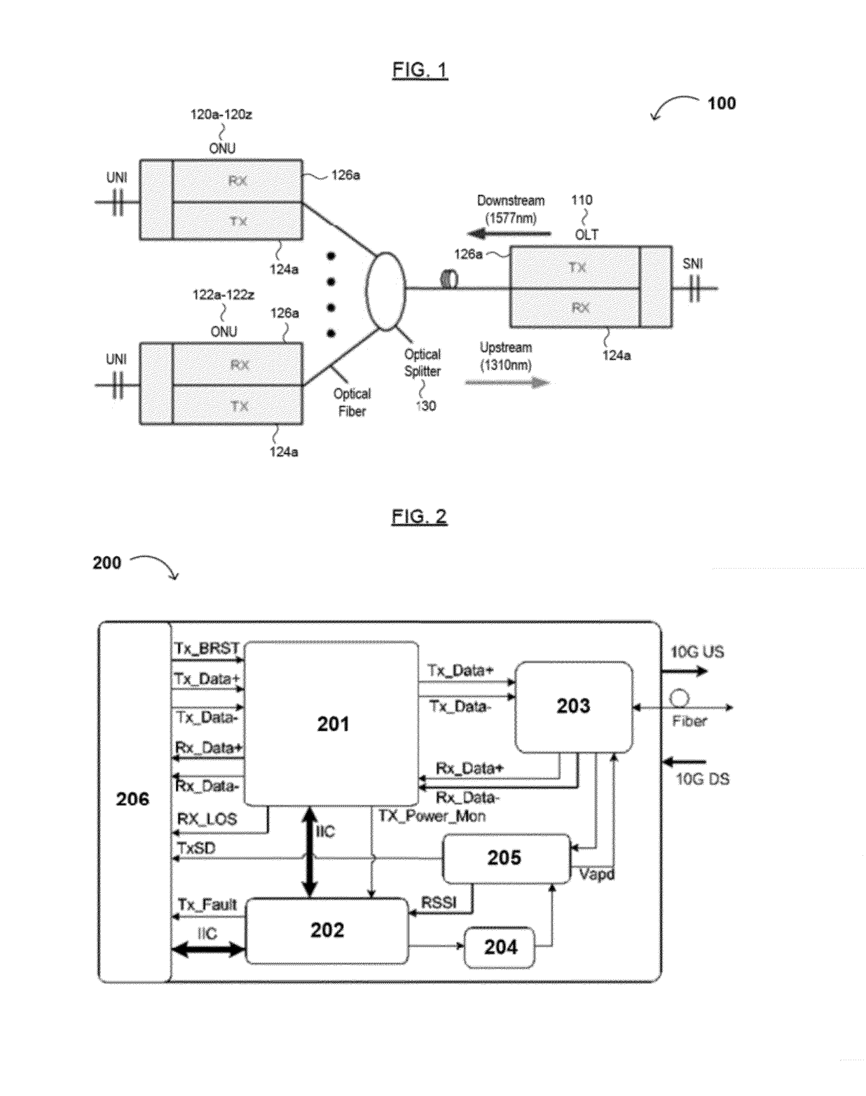

In various embodiments, a 10 G RX electrical signal is transmitted through the SFP+ connector 206. Subsequently, the burst laser driver in unit 201 outputs a modulated signal and a bias current for the BOSA 203, according to one or more predetermined or preprogrammed settings of the control logic 202 to obtain an optical signal satisfying the optical power and the extinction ratio of the system (e.g., system 100 of FIG. 1). Additionally, the burst laser driver can monitor the laser output power and generate laser output power data according to a current signal returned by the control logic 202. Furthermore, the burst laser driver can convert an analog value into a digital value that is subsequently transmitted to the control logic 202. The RX APD bias voltage may be generated by a bias control circuit in the control logic 202. The optical signal is converted to a small-amplitude voltage signal by the APD 205 and TIA (e.g., 310 in FIG. 3) in the BOSA 203, which is transmitted to the 10 G limiting amplifier in unit 201. Once the limiting amplifier in unit 201 receives the small-amplitude voltage signal, the signal is transformed and amplified by a clock and data recovery circuit for subsequent transmission of a 10 G electrical signal having a desired index to the SFP+ connector 206.

The burst laser driver in unit 201 converts modulated voltage signals (e.g., from the host device via connector 206) into a current signal, which drives the laser in the BOSA 203 and generates an optical signal that can be transmitted to a local optical line terminal (OLT) via a fiber. The potential energy of the optical signal is controlled by a logic level signal transmitted to a TX_BRST pin in the connector 206. In certain embodiments, the generation and turn-off time of the TX_BRST signal (which controls entry into and exit from a burst communication mode) are in accordance with one or more standards (e.g., IEEE P802.3av).

In various embodiments, the BOSA 203 comprises a laser and an APD having optical communication wavelengths centered at 1270 nm and 1577 nm, respectively. The intensity of the optical signal converted from the laser and the electric signal amplitude converted from the optical signal by the APD are closely related to the temperature of the laser and the APD, respectively. With the same driving current and APD bias voltage, both laser output optical power and amplitude of the APD electrical output signal decrease with an increase in temperature. To ensure proper characteristics of the optics and to satisfy the optical fiber communication requirements in a commercially accepted temperature range, the control logic 202 compensates for the laser drive current and APD bias current according to the temperature of the laser and the APD, respectively. Consequently, the present transceiver may further include one or more temperature sensors (e.g., temperature sensing circuits) configured to detect the temperature of the laser and/or the APD, and communicate the same to the control logic 202.

Specifically, the control logic 202 compensates for temperature-based variations in the laser current and the APD bias current by utilizing a look-up table. Compensation for the laser current comprises adjusting one or more working currents of the laser, which in some embodiments, include a bias current and a modulation current. By utilizing AC coupling, detecting the bias current can determine the output power by a predetermined or empirically-determined correlation, and detecting the modulation current can determine an extinction ratio by a similarly predetermined or empirically-determined correlation. Thus, two different look-up tables may be included to determine the amount of compensation to be provided to the laser in response to the laser temperature information.

To obtain a desired current value, the laser is operated over the entire commercial operating temperature range of the laser (e.g., approximately 0° C. to about 70° C.) at intervals of, e.g., 3 to 5° C., and the output power and/or wavelength data is analyzed. The power and extinction ratio of the optical output signal are also monitored for stability. The current value output by the control logic 202 instructs the laser driver in unit 201 to output an analog voltage (which may vary according to the temperature of the laser in BOSA 203) using a digital-to-analog converter (DAC) in the control logic 202. Thus, the correlation between the temperature of the laser in BOSA 203 and the current value depends on the correlation between the temperature and a predetermined DAC value. Many predetermined DAC values may be obtained to perform and/or implement the correlation.

To more readily obtain the correlation, key temperature points, which include a minimum of 3 temperature points (e.g., 0° C., 25° C. and 70° C.) can be selected to obtain a set value corresponding to the optical power and extinction ratio at each temperature. According to the linear unity of temperature and a plurality of set values corresponding to various temperature values at a predetermined interval (e.g., 3° C., 5° C., or another value that may be appropriate for a given application) can be determined. A look-up table matching the temperature value and the corresponding DAC value at every predetermined temperature point within the working temperature range (e.g., approximately 0° C. to about 70° C.) can be created accordingly. In one embodiment, the table can be stored in a nonvolatile memory (e.g., a flash memory) associated with and/or accessible by the control logic 202 so that the system 200 retains the data in the event of power interruption and/or failure.

In addition, real-time transceiver temperature information of the transceiver (e.g., the laser in BOSA 203) is sent to the control logic 202, which determines the digital current value corresponding to the power and extinction ratio from the look-up table, and subsequently enters the digital current value into a control register of the DAC. Compensation for the APD bias current is conducted similarly to the laser power. However, one difference is that the DAC (which, in one embodiment, can be a second DAC in the control logic 202) controls a relatively high output voltage generated by an APD booster circuit in APD block 205, so that the look-up table shows a correlation between the temperature of the APD in block 205 and the APD bias current. Subsequently, the control logic 202 sets the APD bias current via a DAC according to the temperature information (obtained by real-time monitoring of the APD 205) and the look-up table that shows the correlation between the temperature and the DAC value.

In various embodiments of the present invention, the transceiver 200 provides a real-time indication of a transmitter slow-down or shut-down indicator (e.g., the TX_SD output) and a transmitter power monitor signal (e.g., the TX_Power_Mon output) in burst mode operations. In addition, the transceiver 200 may provide a receiver activity signal (e.g., the RSSI output) in a continuous operational mode. The receiver activity signal may indicate that the receiver (i) is actively receiving an optical input signal, (ii) has not received an optical input signal for a predetermined period of time (e.g., 1 μsec-100 msec), or (iii) both (i) and (ii).

Referring to FIG. 3, an exemplary SFP+ 10 G EPON ONU transmission circuit, including the receiving part 300 of the 10 G optical signal. The optical signal that is transmitted to the BOSA 303 will be converted to the current signal by the APD 311. Subsequently, the current signal is converted to a voltage signal having a small amplitude by the TIA 310 to transmit the signal to the limiting amplifier 309 and the RX clock signal restitutor 307. Eventually, the 10 Gb/s electric signal satisfying the rising or falling time, amplitude and fluctuation index is delivered. The limiting amplifier 309 and the RX power indicating circuit 315 detect the amplitude of the electric signal output by the TIA 310, and the RX power indicating circuit 315 outputs a loss of signal (LOS) if the detected amplitude is below the threshold value of the control logic 302.

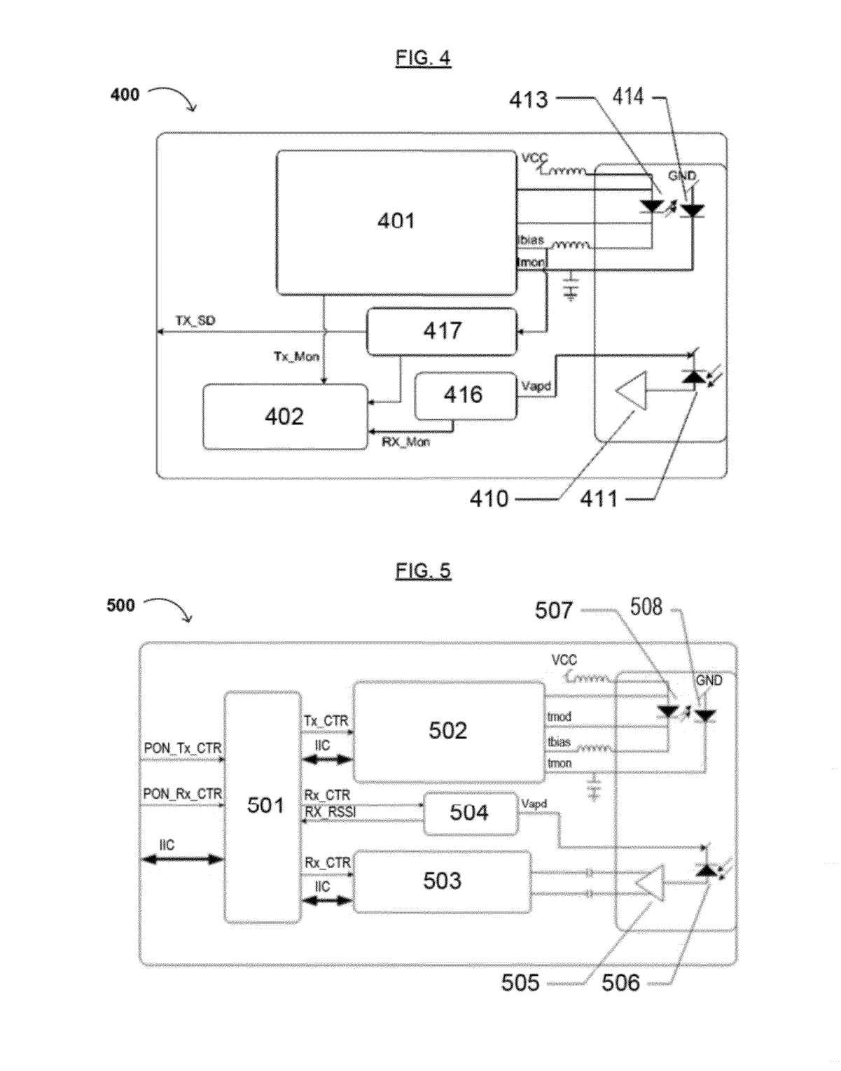

FIG. 3 shows an exemplary monitoring and indicating circuit for a burst output power of a PON transceiver 300, in which the burst laser driver 301 is connected to the laser 313, the optical power of which is detected by photodiode 314 and transmitted to the control logic 202 (FIG. 2) via signal imon. The photodiode 314 (FIG. 3) converts the optical signal from laser 313 to a current signal in a fixed proportion as feedback to the laser driver 301. The laser driver 301 converts the current signal to a voltage signal and obtains the receiver activity (e.g., RSSI) output in the burst mode by sampling an output of an analog-to-digital converter (ADC) in the monitor circuitry (not shown). The control logic 202 (FIG. 2) may sample the ADC output periodically (e.g., in 500 ms increments) and store the sampled data in a control or volatile data storage register. When the laser 313 (FIG. 3) outputs an optical signal having a power, the laser driver 301 must output a bias current. The burst power indicating circuit 417 (FIG. 4) gives an output power indication signal in real time according to the bias current. In one embodiment, the response delay of the output power indication signal is less than 20 nanoseconds. The burst power indicating circuit 417 can also output a transmitter activity signal (e.g., TX_SD) indicating an activity level of the transmitter.

In addition, the RX input signal power is monitored by a photodiode 311 in the APD booster circuit, and the RX power monitoring circuit 416 (FIG. 4) transmits the RX input signal power information in continuous mode to the control logic 402. The RX power monitoring circuit 416 samples the current signal (e.g., Vapd) from the APD 411 and/or the booster circuit, and can obtain or provide a receiver activity signal (e.g., RSSI) in continuous mode either directly from the current signal or from one or more ADCs in the control logic 402.

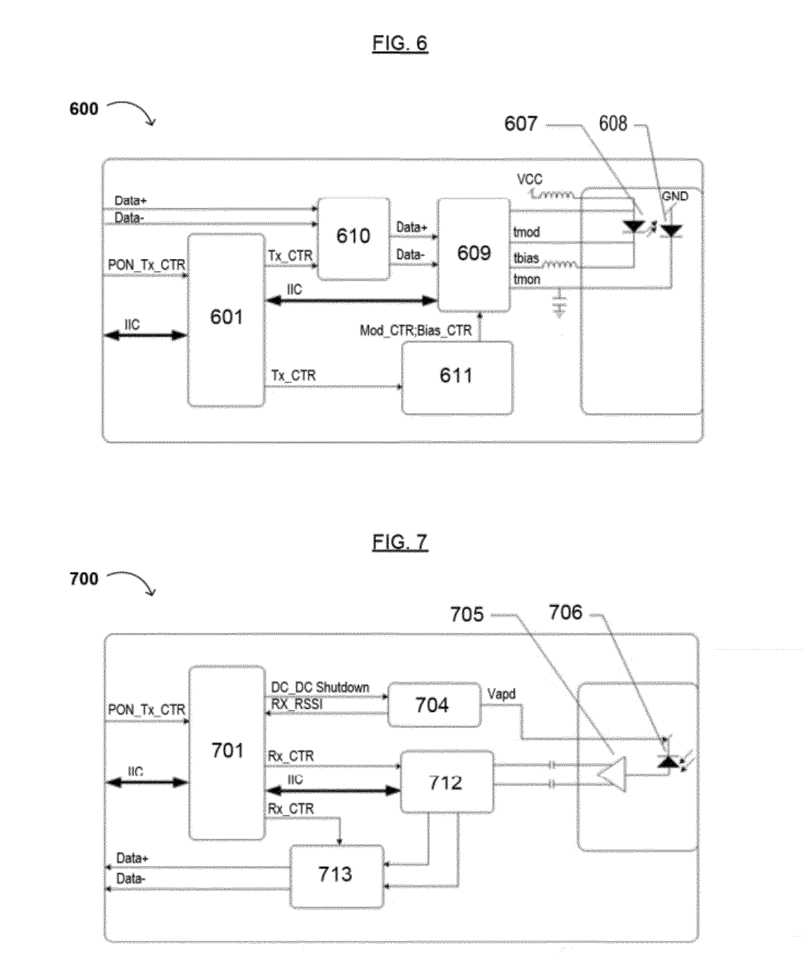

FIGS. 5-7 show exemplary circuitry (including energy saving control circuitry) 500, 600 and 700 for an EPON ONU transceiver, comprising control logic (e.g., a microcontroller unit) 501 (FIG. 5), a laser driving circuit 502, a RX amplification and rectification circuit 503, an avalanche photodiode (APD) bias control circuit 504, a transimpedance amplifier (TIA) 505, an avalanche photodiode (APD) 506, a laser 507, a monitor photodiode (MPD) 508, a laser driver 609 (FIG. 6), a signal equalization circuit 610, a laser driver modulation and/or bias current control circuit 611, a limited amplifier (LA) 712 (FIG. 7), and a clock data recovery (CDR) circuit 713. In one embodiment, the EPON ONU transceiver (e.g., 500, 600 and/or 700) is configured and/or adapted to transmit and receive data at a rate of about 10 Gb/s (10 G), and may be configured to be housed in an SFP or SFP+ package.

The energy-saving circuit of the EPON ONU transceiver 500 shown in FIG. 5 controls energy saving operations of the TX/RX circuitry as may be required by the PON system, and optionally, saves the work status of the TX and/or RX. Thus, system communications may not be affected when the normal working state is resumed.

FIG. 6 shows an exemplary transmitter 600 for an EPON ONU transceiver, including TX energy-saving circuitry. The transmitter 600 comprises control logic (e.g., a microcontroller unit) 601, the laser driver 609, a signal equalization circuit 610, and laser driver modulation and/or bias current control circuit 611. An electrical signal (which may be differential; e.g., Data+/Data−) is transmitted to the transmitter 600 and is delivered to the laser driver 609 after rectification by the equalizer 610. Generally, such circuitry consumes a relatively large amount of power. When upstream transmission of data is not needed (see, e.g., FIG. 1), the laser driver 609 and the equalizer 610 can be quickly turned off by an external logic and/or control signal (e.g., PON_Tx_CTR) to reduce power consumption. In various embodiments, the external logic and/or control signal powers down the laser driver 609 and/or the equalizer 610 in one logic state (e.g., a binary low logic level or digital “0” state) and enables normal operation of the laser driver 609 and/or the equalizer 610 in another logic state (e.g., a binary high logic level or digital “1” state). Similar circuitry and signals are present in the exemplary transceiver of FIG. 5.

The RX amplification and rectification circuit 503 of FIG. 5 is configured to amplify and rectify the small-amplitude voltage signals converted by the TIA 505. The amplification and rectification circuit 503 generally consumes the majority of power in the receiver. All functions of the amplification and rectification circuit 503 can be turned off by the control logic 501 delivering a logic signal (e.g., Rx_CTR) when the downstream data transmission function (see FIG. 1) is idle. The control logic 501 delivers the logic signal (e.g., Tx_CTR, Rx_CTR) configured to turn on and off the respective functional TX/RX circuitry according to the TX/RX control signal (e.g., PON_Tx_CTR, PON_Rx_CTR) produced by the PON system. In addition, the control logic 501 can store and/or provide monitoring information with respect to the work status of any or all functional circuits in the transceiver via one or more IIC interfaces with control logic 501, as well as granting to the PON system access to ONU energy-saving software (which may be stored in memory in or associated with the control logic 501). Alternatively, if the energy-saving software is stored in memory in or associated with the PON system, the control logic 501 may, on demand and/or periodically, access such energy-saving software.

Referring to FIG. 6, the control logic 601 controls the working status of the TX signal equalization circuit 610 by a control and/or logic signal (e.g., Tx_CTR, which may be delivered by the ONU) to determine energy savings. The energy saving of the laser driver 609 includes two aspects. First, the power consumed by the circuit of the laser driver 609, which is controlled by the microcontroller 601 per energy-saving logic, is saved by turning off the laser driver circuitry (e.g., by disconnecting power to the laser driver circuitry using one or more switches between the power supply and the laser driver circuitry). Secondly, the energy consumed by the modulation and bias current control circuit 611, which turn the laser 607 on and off and which also receives an energy-saving control and/or logic signal (e.g., Tx_CTR, which may be the same as or different from the control and/or logic signal sent to the laser driver 609), can be saved by turning off the modulation and/or bias current control and/or generation functions of modulation and bias current control circuit 611 (e.g., by disconnecting power to the modulation and/or bias current control and/or generation function blocks using one or more switches). The status of the laser 607 needs to be saved (e.g., as described herein) when the TX circuitry (e.g., 610, 611) is turned off.

FIG. 7 shows an exemplary receiver 700 for an EPON ONU transceiver, including RX energy saving control circuitry. The receiver 700 comprises control logic (e.g., a microcontroller unit) 701, a PD bias control circuit 704, a TIA 705, a photodiode (PD) 706, an amplification and/or rectification circuit 712, and a clock data recovery (CDR) circuit 713. The energy consumption of the PD bias control circuit 704 is turned off or enabled by the control logic 701 according to an energy-saving control and/or logic signal (e.g., PON_Rx_CTR) from the PON system. The amplifier 712 (which in one embodiment is a limiting amplifier [LA]) and the CDR circuit 713 are also turned off or enabled by the control logic 701 in accordance with an energy-saving control and/or logic signal (e.g., Rx_CTR), similar to the laser driver 609 and the modulation and bias current control circuit 611 in the exemplary transmitter 600 of FIG. 6. Furthermore, the control logic 701 can obtain the work status of the receiver circuitry via the IIC interface. Thus, the TX energy saving circuit of FIG. 6 and the RX energy saving circuit of FIG. 7 are capable of quickly responding to the energy-saving instructions of the PON system and providing acceptable switching periods of energy saving modes and working modes, thereby minimizing waste of the PON system bandwidth resources when the ONU transceiver is in an idle (e.g., Sleep and Periodic Wake-up [SPW]) mode.

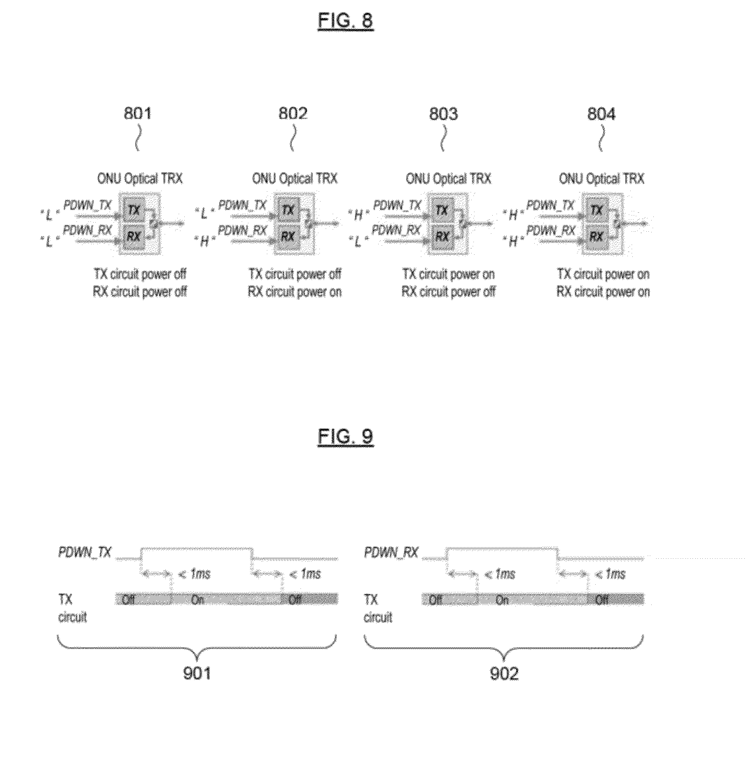

The exemplary EPON ONU transceiver with energy-saving TX and RX functions (e.g., as depicted with regard to FIGS. 5-7) has four (4) working states 801-804, as shown in FIG. 8. For example, in a first state 801, both the transmitter TX and the receiver RX in the transceiver 810 are in a power-down state in response to a control signal (PDWN_TX or PDWN_RX) having a first predetermined logic level (e.g., low or “L”) corresponding to the power-down or power-off mode. In a second state 802, the transmitter TX is in a power-down state in response to the control signal (PDWN_TX) having the first predetermined logic level, but the receiver RX in the transceiver 810 is in a normal operating mode in response to the corresponding control signal (PDWN_RX) having a second predetermined logic level (e.g., high or “H”). In a third state 803, the transmitter TX is in a power-on state or normal operating mode in response to the control signal (PDWN_TX) having the second predetermined logic level (e.g., “H”), but the receiver RX is in a power-down or power-off mode in response to the control signal (PDWN_RX) having the first predetermined logic level (e.g., “L”). In a fourth state 804, both the transmitter TX and the receiver RX in the transceiver 810 are in a power-on state or normal operating mode in response to the control signal(s) (PDWN_TX and PDWN_RX) having the second predetermined logic level (e.g., “H”).

FIG. 9 is a diagram showing exemplary turn-on and turn-off times for the exemplary EPON ONU transceiver 500-700 of FIGS. 5-7. In an energy-saving PON system, it is comparatively easy to save energy at the ONU transmitter (e.g., transmitter 600 in FIG. 6). Subsequent to receiving the OLT energy-saving instructions (e.g., the PDWN_TX or PDWN_RX signal in FIG. 9), the energy-saving control logic in the ONU transmitter turns off one or more functional circuits in the transmitter itself.

However, energy saving at the receiver (e.g., receiver 700 in FIG. 7) is comparatively difficult, because the Optical Net Terminal (ONT) cannot receive system instructions. To resolve this problem, a “Sleep and Periodic Wake-up” (SPW) mode may be adopted in the energy-saving PON system. In the SPW mode, the ONU transceiver in sleep mode (e.g., power-down or energy-saving mode) wakes up periodically and communicates with the OLT to determine whether to stay in the sleep mode. When no downstream communication is needed from the ONU transceiver, the ONU transceiver stays in an energy-saving (e.g., sleep) mode. However, when downstream communications are needed, the ONU transceiver switches to a working mode. According to this operation principle, the ONU is able to save energy effectively. However, switching the work status and confirming a need (or lack of need) for communications from the ONU and the OLT occupy some bandwidth resources, which may cause overall slower switching. The more bandwidth resources occupied in switching the work status and confirming the appropriate work status, the less network utilization occurs. When considering network utilization (e g , minimizing impact on bandwidth), an acceptable time for the ONU switching work status in the PON system (e.g., the transmitter and/or receiver) may be from about 1 μs to about 1 ms, or any range of values therein (e.g., 1-10 μs). In addition, when the ONU receiver is in sleep or power-down mode, one may confirm the appropriate work status of the ONU receiver (e.g., determine whether downstream communications are needed) periodically (e.g., once every 10 μs, 10 μs, 1 ms, 10 ms, or other value that is appropriate in consideration of a balance between optimal energy savings and optimal performance).

Referring to FIG. 9, a waveform/graph 901 shows a correlation between the state of the control signal (e.g., PDWN_TX) and the on/off state of the transmitter TX circuit(ry), as well as an exemplary response time for the transmitter TX circuit(ry) to change operational states (e.g., from off to on, or vice versa), and a waveform/graph 901 shows a correlation between the state of the control signal (e.g., PDWN_RX) and the on/off state of the receiver RX circuit(ry), as well as an exemplary response time for the receiver RX circuit(ry) to change operational states (e.g., from off to on, or vice versa). As shown in graphs 901-902, a low logic level or binary “0” state may be correlated with the power-off state of the TX or RX circuitry, although a different configuration (e.g., a high logic level or binary “1” state may be correlated with the power-off state) is possible. In addition, both the transmitter TX circuitry and the receiver RX circuitry may have a response time of less than 1 μs to change from the power-off state to the power-on state in response to a change in the control signal state, and a response time of less than 1 μs to change from the power-on state to the power-off state in response to a complementary change in the control signal state.

### CONCLUSION/SUMMARY

Thus, the present invention provides a high speed, bi-directional optical network transceiver, particularly circuits and devices therefor, and method(s) of making and/or using the same. In one embodiment, the transceiver is a 10 G Ethernet passive optical network (EPON) transceiver, and in another embodiment, the transceiver is housed or enclosed in a small form factor pluggable (SFP or SPF+) compliant package. Embodiments of the present invention also provide a 10 G bi-direction transceiver with energy-saving functions, circuits and devices therefor, and method(s) of making and/or using the same.

The high-speed bi-directional transceiver generally comprises a burst laser driver; a burst output power monitoring and indicating circuit; control logic (e.g., a microcontroller unit); bi-directional optics; a photodiode bias control circuit; a limiting amplifier; and a receiver optical power monitoring circuit. Optionally, the present transceiver includes (and is packaged in) a small form factor pluggable (SFP+) connector housing. The present ONU transceiver provides an effective solution to reduce energy and/or power consumption during a silent operational mode, without significant adverse effects on normal communications in the PON system.

Furthermore, the energy-saving bi-directional transceiver generally comprises a transmitter (TX) energy-saving circuit; a TX burst holding circuit; a receiver (RX) energy-saving circuit; a RX continuous holding circuit; and control logic (e.g., a microcontroller, microprocessor, signal processor, ASIC, etc.) configured to control one or more of the TX energy-saving circuit, TX burst holding circuit, RX energy-saving circuit and RX continuous holding circuit. In accordance with one or more control signals, the TX energy-saving circuit turns off some or all functional components of the transmitter during an idle time (e.g., when the transmitter enters an idle or stand-by mode), and together with the burst holding circuit, quickly resumes normal functions during working time (e.g., when the transmitter is to enter an operational mode). The RX energy-saving circuit quickly turns off one or more blocks of the receiver circuitry during a silent time (e.g., an idle or stand-by mode) and, together with the RX burst holding circuit, enables the receiver to resume a working state (e.g., a normal operational mode) according to system requirements. The control logic is also capable of saving the TX and/or RX working status, and provides access to and/or by energy-saving software.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A transceiver, comprising:
a laser driver;
a laser configured to receive a drive current from the laser driver;
control logic configured to (i) monitor a temperature of the laser via an internal sampling circuit and (ii) compensate the drive current of the laser driver for variations in the temperature of the laser;
bi-directional optics;
a photodiode bias control circuit configured to apply a bias voltage to the laser; and
a limiting amplifier configured to receive a data input signal from the bi-directional optics.

2. The transceiver of claim 1, further comprising a transimpedance amplifier (TIA) configured to convert a received optical signal to the data input signal for said limiting amplifier.

3. The transceiver of claim 1, wherein the control logic comprises a microcontroller unit or microprocessor.

4. The transceiver of claim 1, further comprising a small form-factor pluggable (SFP+) connector configured to house or contain the transceiver.

5. The transceiver of claim 2, further comprising a receiver power indicating circuit, wherein the limiting amplifier and the receiver power indicating circuit are configured to detect an amplitude of an electrical signal delivered from the TIA, and when the amplitude is below a predetermined threshold, the receiver power indicating circuit indicates a loss of signal (LOS).

6. The transceiver of claim 1, wherein the control logic is configured to monitor the temperature of the laser real-time, compensate an optical output power and modulation current of the laser, and compensate the bias voltage according to a lookup table.

7. The transceiver of claim 1, further comprising an optical output power monitoring circuit configured to indicate an optical power of the laser to the control logic.

8. The transceiver of claim 1, further comprising an optical power indicating and receiver optical power monitoring circuit.

9. The transceiver of claim 1, wherein the laser driver comprises a burst mode laser driver.

10. The transceiver of claim 1, wherein the laser comprises an avalanche photodiode (APD), and the photodiode bias control circuit comprises an APD bias control circuit.

11. A transceiver, comprising:
a transmitter burst holding circuit;
a transmitter energy-saving circuit configured to turn on and off one or more components of the transmitter burst holding circuit when a transmitter including the transmitter burst holding circuit is idle;
a receiver continuous holding circuit;
a receiver energy-saving circuit configured to turn on and off one or more components of the receiver continuous holding circuit when a receiver including the receiver continuous holding circuit is idle; and
control logic configured to save a status of a receiver including the receiver continuous holding circuit, provide access to energy-saving software, and control one or more of the transmitter energy-saving circuit, the transmitter burst holding circuit, the receiver energy-saving circuit and the receiver continuous holding circuit.

12. The transceiver of claim 11, wherein the control logic comprises a microcontroller unit, microprocessor, signal processor or ASIC.

13. The transceiver of claim 11, wherein the transceiver is configured to (i) turn off one or more functional components of the transmitter when a function of the receiver is not needed and (ii) turn on said one or more functional components of the receiver when uplink transmissions are needed from the receiver.

14. The transceiver of claim 11, wherein the control logic comprises logic to save a work status of circuitry in the transmitter and of circuitry in the receiver.

15. The transceiver of claim 11, wherein when the receiver is in an energy-saving mode, the receiver switches periodically to a working mode and determines whether to stay in said energy-saving mode, and if no downlink communications are needed, the receiver stays in the energy-saving mode, but if downlink communications are needed, then the receiver switches to the working mode.

16. The transceiver of claim 11, wherein the control logic (i) delivers a signal configured to turn off all functional components in the transmitter when the transmitter does not receive a downstream signal; (ii) delivers one or more signals in accordance with control signals from a network coupled to the transceiver configured to turn on and/or off said functional components and/or said components of the receiver; (iii) provide working status data of functional circuits on the transceiver; and (iv) provide the network with access to energy-saving software on the transceiver.

17. The transceiver of claim 11, wherein the transmitter burst holding circuit comprises a laser, a signal equalization circuit and a laser driver providing a drive current to the laser, wherein the control logic controls a working status of the laser driver and/or signal equalization circuit.

18. The transceiver of claim 17, wherein the transmitter burst holding circuit further comprises a modulation and bias current control circuit configured to provide a bias voltage to the laser, the control logic turns the laser on and off by turning the laser driver on and off, respectively, and the working status of the laser is saved when the laser driver is turned off.

19. The transceiver of claim 18, wherein the receiver continuous holding circuit comprises an amplifier and a clock data recovery (CDR) circuit, and the control logic turns the modulation and bias control circuit, the amplifier and the CDR circuit on or off in accordance with one or more energy-saving control signals from a network coupled to the transceiver.

20. A method of saving energy in a bi-directional transceiver, comprising:
operating a transmitter in the transceiver, the transmitter comprising a laser, a signal equalization circuit and a laser driver providing a drive current to the laser;
operating a receiver in the transceiver, the receiver comprising an amplifier and a clock data recovery (CDR) circuit;
configuring control logic in the transceiver to turn off (i) one or more of the signal equalization circuit and the laser driver when the transmitter is idle and (ii) one or more of the amplifier and the CDR circuit when the receiver is idle.
